(19) United States
(12) Patent Application Publication
(10) Pub. No.: US 2008/0271502 A1
(43) Pub. Date: Nov. 6, 2008

(54) Actuation Device for a Lock

(76) Inventor: Horst Kutschat, Wuppertal (DE)

Correspondence Address: LACKENBACH SIEGEL, LLP, LACKENBACH SIEGEL BUILDING, 1 CHASE ROAD, SCARSDALE, NY, 10583, US

(21) Appl. No.: 12/065,226

(22) PCT Filed: Aug. 11, 2006
(86) PCT No.: PCT/EP2006/007987

§ 371 Date: Jul. 1, 2008

(30) Foreign Application Priority Data
Aug. 30, 2005 (DE) 10 2005 041 081.2

(51) Int. Cl. E05B 13/10

(52) U.S. Cl. 70/224; 70/277

(57) ABSTRACT

The invention relates to an actuating apparatus for a lock mechanism, in particular of a door or flap of a motor vehicle, in particular of a tractor, having a handle body, in which an actuating device for driving an actuating element for the lock mechanism is mounted in a handle-body end region, a moveable coupling link being provided, with which the actuating device can be brought out of operation, the coupling link being connected driveably to a locking device having a remote-controllable driving device, and the locking device being accommodated in other subregions of the handle body and the driving device being a rotation drive.

The invention relates to an actuating apparatus for a lock, in particular a door lock and/or flap lock of a motor vehicle, in particular of a tractor, according to the preamble of claim 1.

Known actuating apparatuses for motor vehicle locks have a handle body, in which a pushbutton with a lock cylinder is mounted displaceably. The pushbutton can be transferred from a first operating state into a second operating state and vice versa by means of a key which fits into the lock cylinder. In the first operating state, a lock can be actuated by means of the push-button, so that it opens. In the second operating state, the pushbutton, when actuated, executes an “empty stroke”, so that despite the button being pressed, an actuation, i.e. an opening of the lock, does not occur. The associated motor vehicle door or motor vehicle flap is therefore locked.

Furthermore, it is known to enable the locks to interact with a remote-controllable locking unit, for example within the context of a central locking system of the motor vehicle. In the case of known arrangements of actuating apparatus and lock together with a remote-controllable locking unit, it is disadvantageous that a large amount of space is a necessity and a multiplicity of parts and a high structural outlay are required. Furthermore, it is expensive and laborious to install and secure the components.

It is the object of the invention to provide an actuating apparatus for a lock, in particular a motor vehicle door lock or flap lock, in particular for a tractor, which does not need much space and has a remote-controllable locking and/or unlocking functionality.

This object is achieved by an actuating apparatus having the features of claim 1. Advantageous embodiments are indicated in the subclaims which are dependent thereon.

The invention is described below by way of example with reference to the drawing, in which:

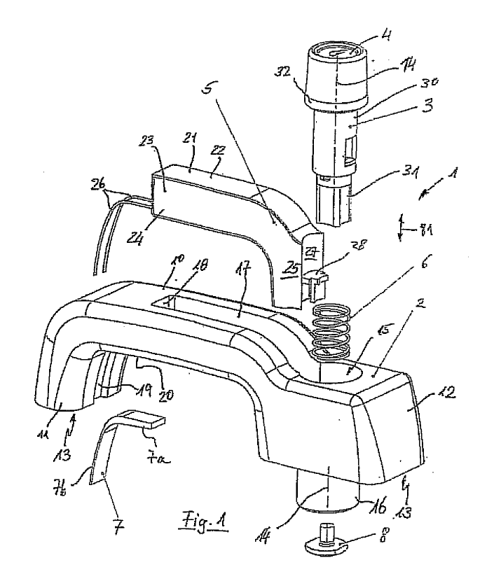

FIG. 1 shows a perspective exploded illustration of an actuating apparatus;

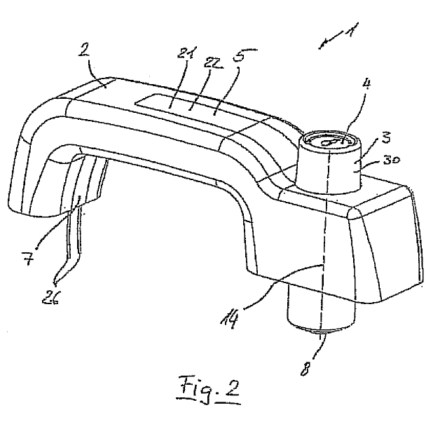

FIG. 2 shows the actuating apparatus according to FIG. 1 in a perspective assembly illustration;

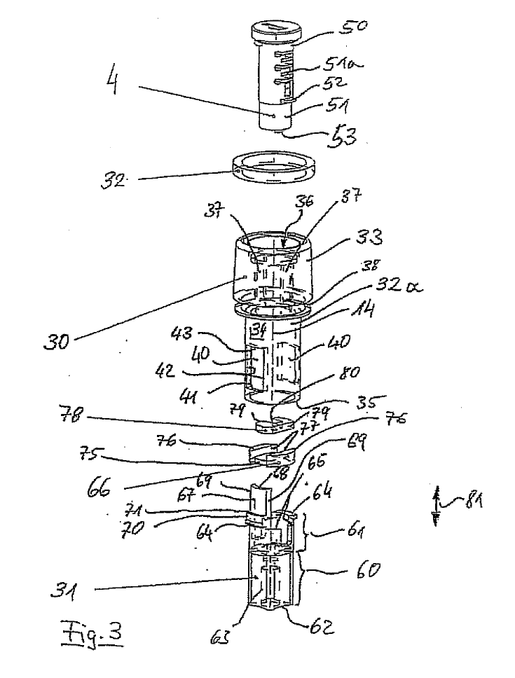

FIG. 3 shows a perspective exploded illustration of a pushbutton of the actuating apparatus according to FIG. 1;

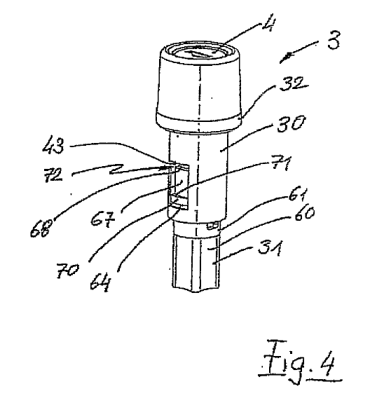

FIG. 4 shows a perspective assembly illustration of the pushbutton according to FIG. 3;

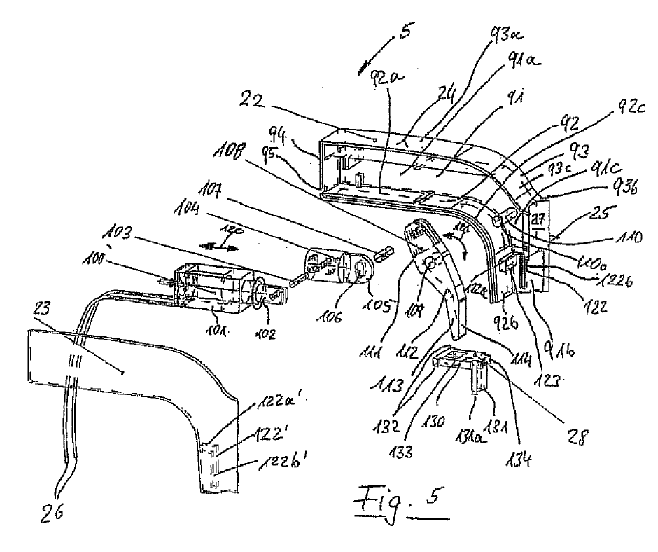

FIG. 5 shows a perspective exploded illustration of a locking device of the actuating apparatus according to FIG. 1;

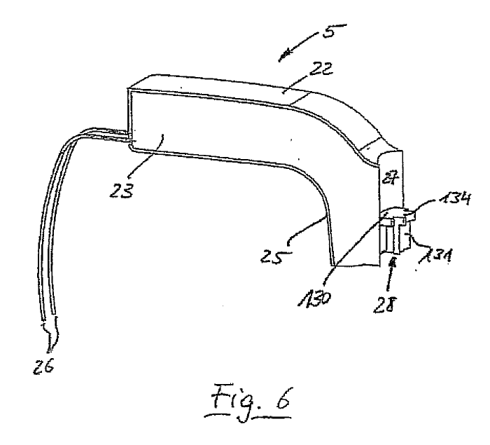

FIG. 6 shows the locking device according to FIG. 5 in a perspective assembly illustration;

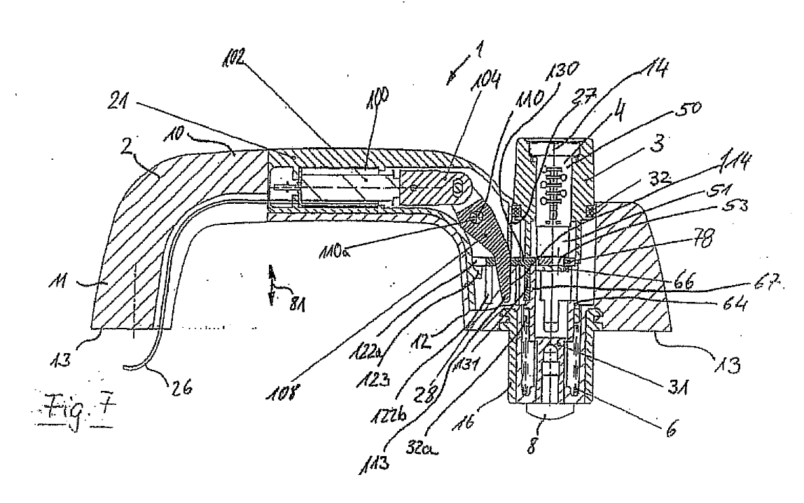

FIG. 7 shows a longitudinal section through the actuating apparatus according to FIG. 1 in a first operating position with the push-button not actuated;

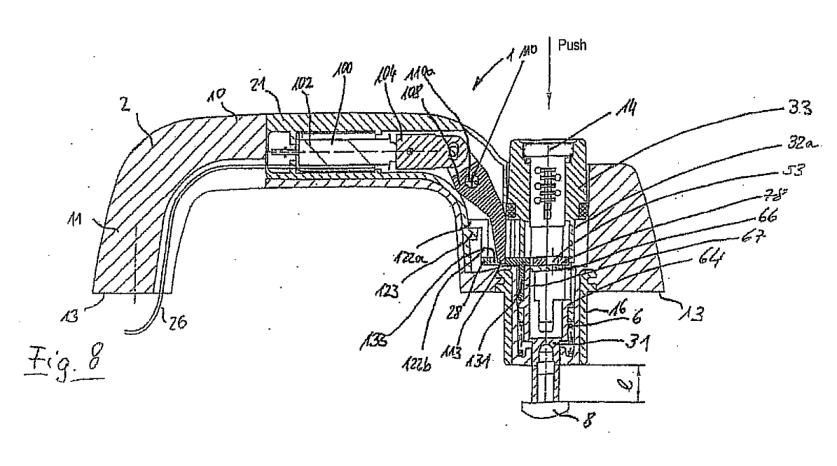

FIG. 8 shows the actuating apparatus according to FIG. 7 with the pushbutton actuated;

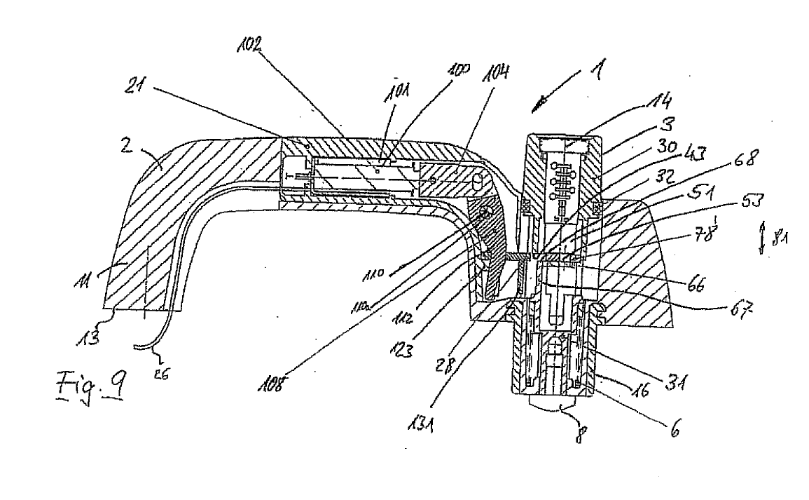

FIG. 9 shows a longitudinal section through the actuating apparatus in a second operating position with the pushbutton not actuated;

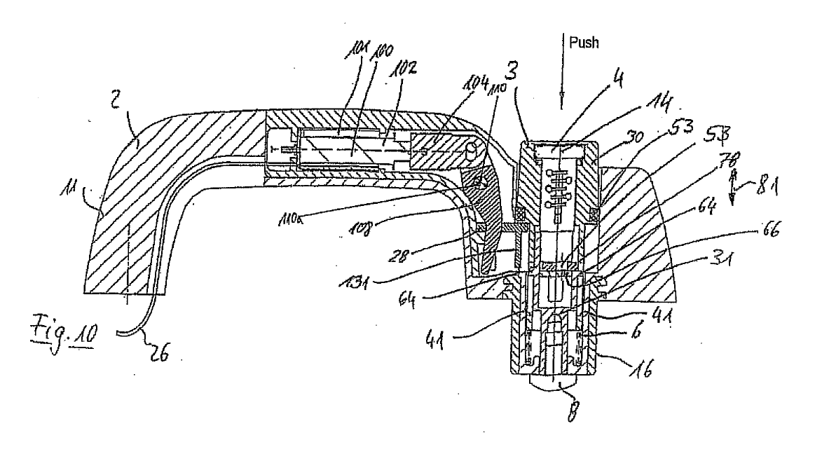

FIG. 10 shows the actuating apparatus according to FIG. 9 with the pushbutton actuated;

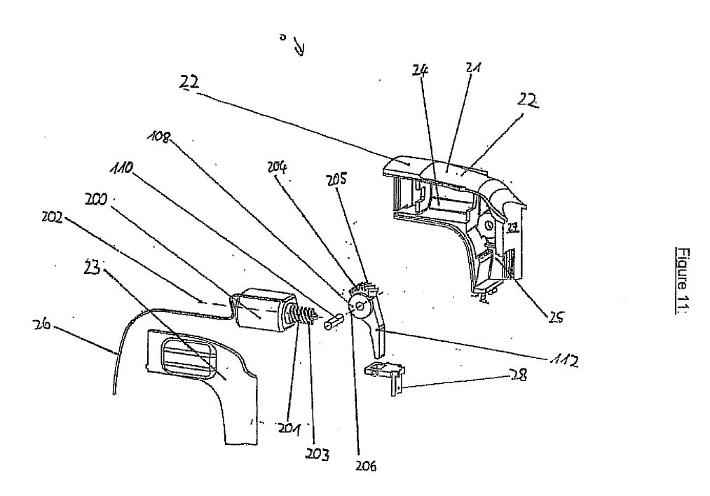

FIG. 11 shows a perspective exploded illustration of a locking device of an actuating apparatus according to the invention according to a first embodiment;

FIG. 12 shows a longitudinal section through an actuating device according to the invention in a first operating position with the pushbutton not actuated;

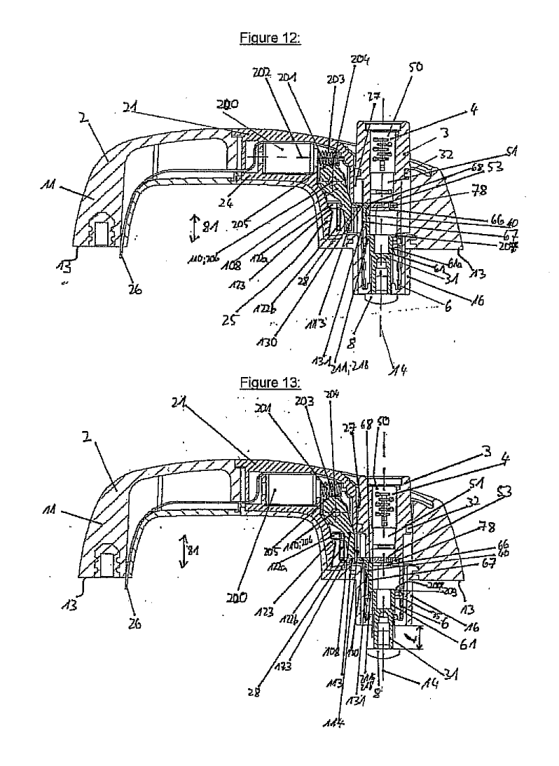

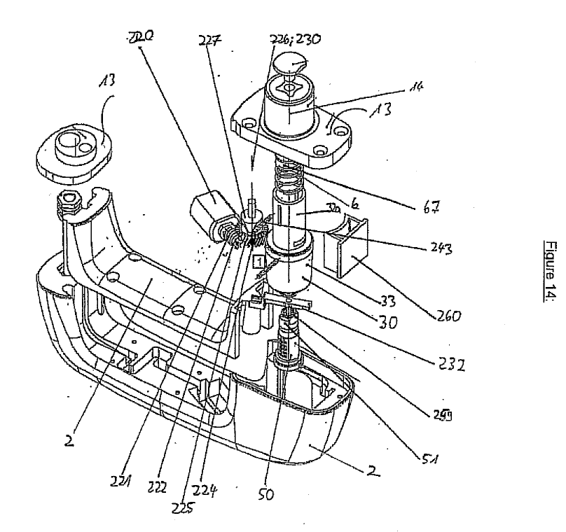

FIG. 13 shows the actuating apparatus according to FIG. 12 with the pushbutton actuated;

FIG. 14 shows a perspective exploded illustration of an actuating apparatus according to the invention according to a further embodiment;

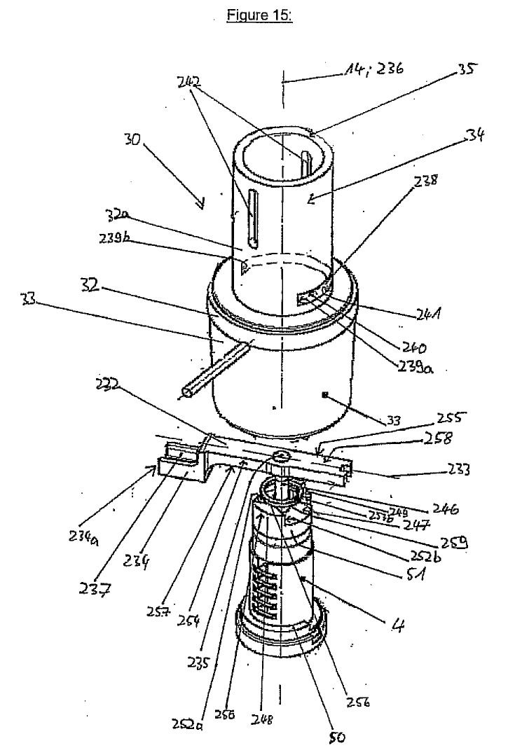

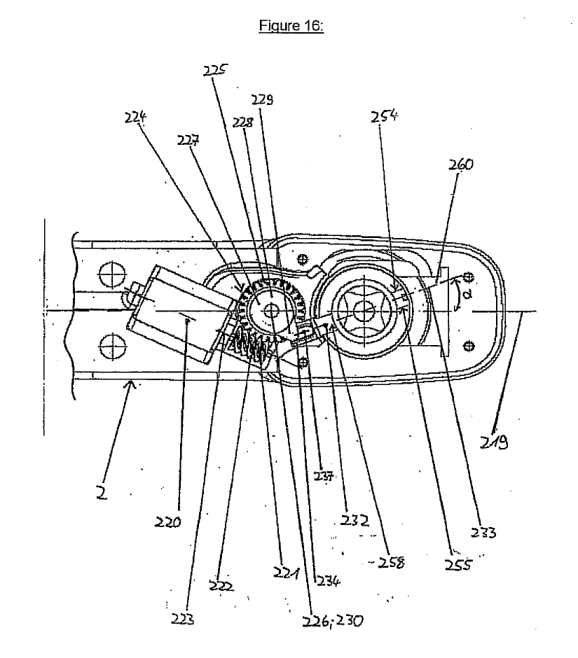

FIG. 15 shows a perspective exploded illustration of a pushbutton of the actuating apparatus according to FIG. 14 without a pushbutton lower part and with a coupling lever;

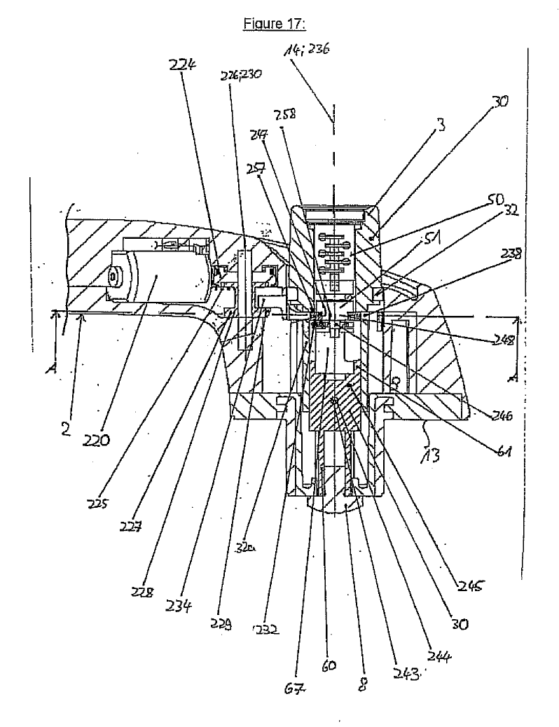

FIG. 16 shows a bottom view of the actuating apparatus according to FIG. 14 in a first operating position without a lower covering of a handle body;

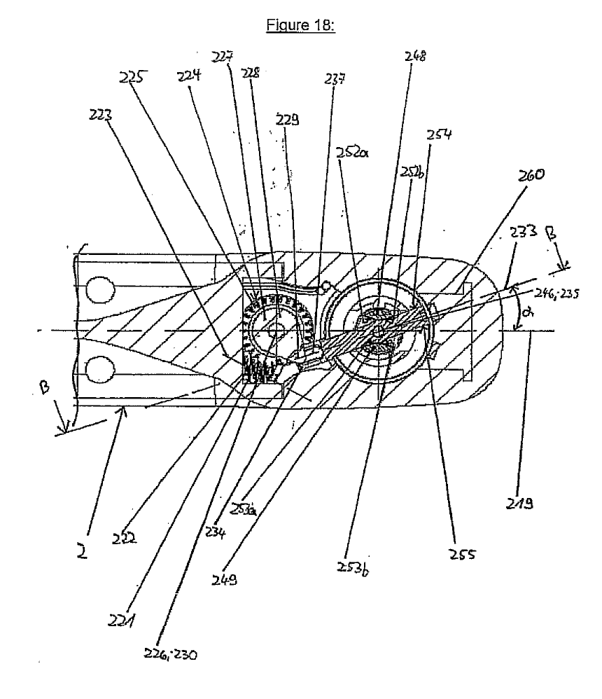

FIG. 17 shows a longitudinal section through the actuating apparatus according to FIG. 16 with the pushbutton not actuated;

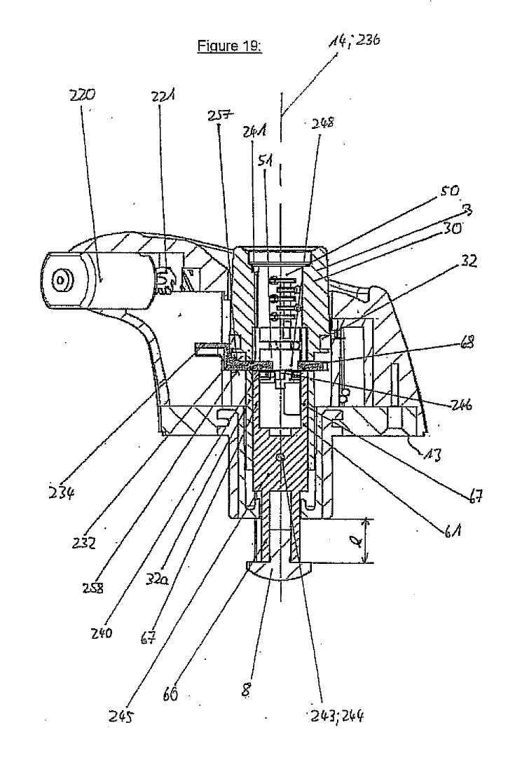

FIG. 18 shows a cross section through the actuating apparatus according to FIG. 17 along the line A-A;

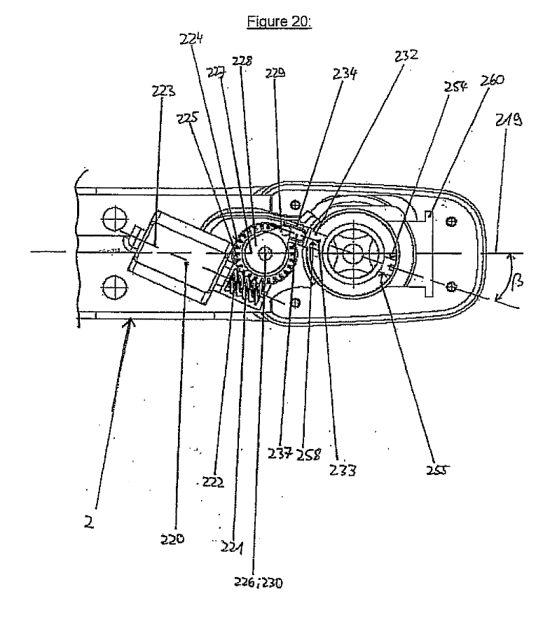

FIG. 19 shows a section through the actuating apparatus according to FIG. 18 along the line B-B with the pushbutton actuated;

FIG. 20 shows a bottom view of the actuating apparatus according to FIG. 14 in a second operating position without a lower covering of a handle body;

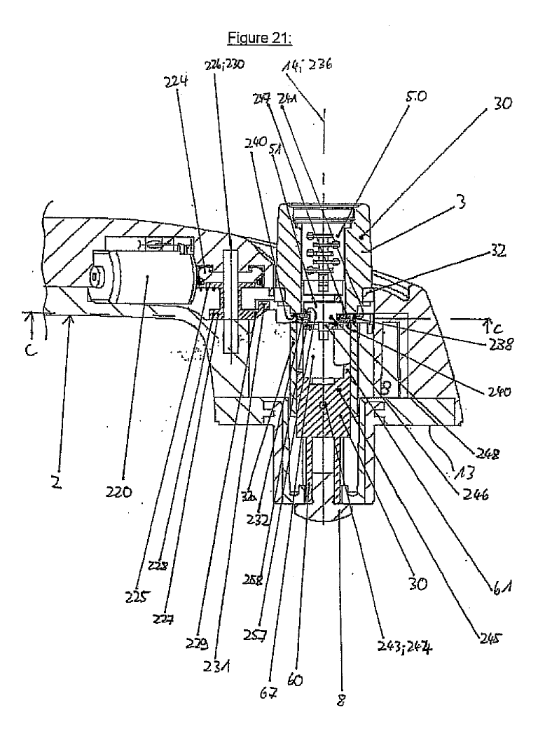

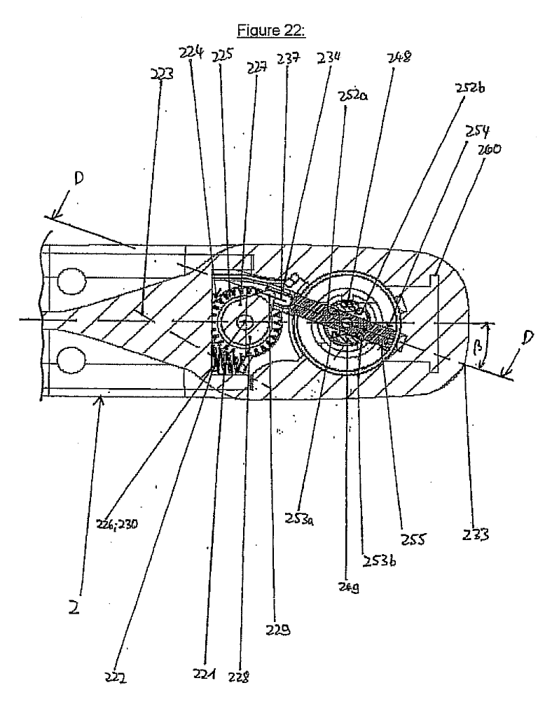

FIG. 21 shows a longitudinal section through the actuating apparatus according to FIG. 20 with the pushbutton not actuated;

FIG. 22 shows a cross section through the actuating apparatus according to FIG. 21 along the line C-C;

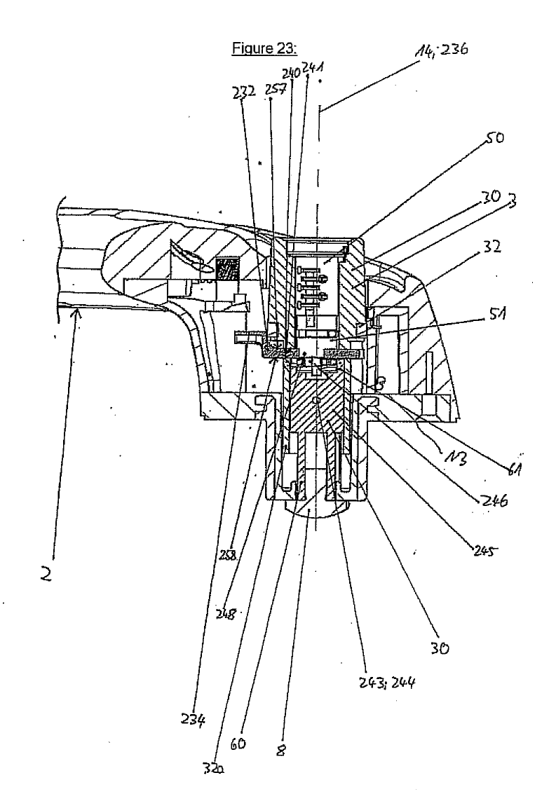

FIG. 23 shows a section through the actuating apparatus according to FIG. 22 along the line D-D with the pushbutton actuated.

An actuating apparatus 1 (FIG. 1) has a handle body 2, and as actuating device a pushbutton 3 with a lock cylinder 4, a motor-driveable locking device 5, a compression spring 6, and a covering 7 and an actuating element 8.

As viewed from the side, the handle body 2 is designed an essentially U-shaped handle bracket, with a base limb 10, a first U-limb 11 and a second U-limb 12. The U-limbs 11, 12 each have end sides 13 with which the handle body 2 can be fastened, for example, to a door outer skin of a motor vehicle. The second U-limb 12 has, along an actuating longitudinal axis 14, which extends in the limb direction and is also the longitudinal movement axis of the pushbutton 3 together with the lock cylinder 4, a plug-in opening 15 for the pushbutton 3. The plug-in opening 15 opens into a plug-in channel 15a which completely penetrates the second U-limb 12. A bushing-shaped receiving device 16 which has an essentially cylindrical outer shape extends from the end side 13 of the second U-limb 12. An elongate groove or a blind-hole recess 17 extends away from the plug-in opening 15, and opening into the latter and to the outside, to over approximately ⅔ of the base limb 10, said elongate groove or blind-hole recess following the contour of the U-limb 12 and of the base limb. The blind-hole recess 17 in the base limb 10 is connected in the region of its end 18 lying opposite the plug-in opening 15, just above its groove base, to a groove-type depression 19 or a groove, which is open opposite or extends from an inside 20 of the base limb 10 and of the first U-limb 11 as far as the end side 13 of the first U-limb 11, or said blind-hole recess 17 follows the contour of these parts. The groove-type depression 19 can be covered or can be closed by means of the covering 7, which is of essentially L-shaped design with a first covering limb 7a and a second covering limb 7b.

The locking device 5 is designed in the manner of a plug-in module for plugging into the blind-hole recess 17 of the handle body 2 and has a cross-sectionally rectangular housing 21 with a housing main part 22 and a lateral housing cover 23. As viewed from the side, the housing 21 is of essentially L-shape design and has a first, longer L-limb 24 and a second, shorter L-limb 25. The first limb 24 corresponds to the blind-hole recess 17 in the base limb 10. The second limb 25 corresponds to the blind-hole recess 17 in the region joining the latter to the plug-in opening 15, and, in the assembled state, comes to lie in the transition region between the second U-limb 12 and the base limb 10. Electric lines 26 lead off at the free end of the first limb 24. The second limb 25 has, toward the plug-in opening 15, an outer surface 27 which is designed in the shape of a section of a concave cylinder, such that the plug-in opening 15 together with the outer surface 27 is circular in cross section. A projecting slide 28, which is described in more detail further below, projects from the outer surface 27 of the locking device 5 for a distance into the plug-in opening 15.

The pushbutton 3 has a pushbutton upper part 30 and a pushbutton lower part 31. The lock cylinder 4 sits in the pushbutton upper part 30 by means of a clip connection. A sealing ring 32 which interacts with the inside of the plug-in opening 15 and seals off the gap between the pushbutton upper part 30 and the plug-in opening 15 is arranged on the outside of the pushbutton upper part 30.

In the following, the construction of the pushbutton 3, which together with the actuating element 8 forms an actuating device, together with the lock cylinder 4 will be described in more detail with reference to FIGS. 3 and 4. The pushbutton upper part 30 has a cylindrical tube section 32a and a compressive part 33. The cylindrical tube section 32a is a thin-walled, cylindrical tube with a tube outside 34 and a free annular end surface 35. Opposite the annular end surface 35, the compressive part 33 is connected integrally to the cylindrical tube section 32a. The compressive part 33 is larger in outside diameter than the cylindrical tube section 32a and has a stepped hole 36 with the actuating longitudinal axis 4 as the central axis. The stepped hole 36 has longitudinal grooves 37 on the inside for receiving small lock plates of the lock cylinder 4. On the outer circumference, the compressive part 33 has, adjacent to the cylindrical tube section 32, an annular groove 38 for receiving the sealing ring 32.

The cylindrical tube section 32a has opposite, rectangular window-type cutouts 40 with a lower edge 41, two side edges 42 and an upper edge 43. The two window-type cutouts 40 have the same extent in terms of area. The lower edge 41 and the upper edge 43 are each parallel to the annular end surface 35. The side edges 42 are parallel to the actuating longitudinal axis 14.

The lock cylinder 4 has a blocking body 50 and a rotating body 51. Small lock plates 51 are mounted in a known manner in the blocking body 50. Furthermore, the blocking body 50 has a tumbler 52 as a means of securing it against falling out, said tumbler being intended in a known manner to prevent the blocking body 50 from rotating in the compressive part 33. The rotating body 51 has, eccentrically with respect to the actuating longitudinal axis 14, an eccentric nipple 53 which protrudes downward for a distance in the axial direction from the rotating body 51.

The pushbutton lower part 31 has a punch section 60 and a tube section 61. The punch section 60 has, along the actuating longitudinal axis 14, at the free end 62 of the punch section 60, a threaded hole 63 for receiving the actuating element 8. The tube section 61 has an outside diameter which corresponds to the inside diameter of the cylindrical tube section 32a of the pushbutton upper part 30. The tube section 61 extends away for a distance from the punch section 60 and, corresponding to the window-type cutouts 40, has latching projections 64 which are dimensioned, with regard to their three-dimensional shape, in such a manner that they can interact in a latching manner with the lower edge 41 of the window-type cutouts 40. With regard to the width, the latching projections 64 are dimensioned in such a manner that they can be moved up and down in the window-type cutouts 40 guided by the side edges 42. Adjacent to the latching projections 64, the tube section 61 has end steps 65 situated somewhat lower down. The end steps 65 serve to support a slide guide 66 which is described in more detail further below. Aligned in the longitudinal direction, one of the latching projections 64 has a stop tab or stop web 67 as an extension of the tube section 61 upward. The stop tab 67 has a three-dimensional shape in the form of a section of a cylindrical tube wall, and has an upper, free end edge 68 and side edges 69. Directly in the longitudinal axial direction 14 adjacent to the associated latching projection 64, the stop tab 67 has an outwardly projecting, curved stepped shoulder 70 which has a step upper side 71 in the form of a section of a circular ring. In the assembly of the pushbutton upper part 30 and of the pushbutton lower part 31, the stepped shoulder 70 is situated in one of the windows 40 of the pushbutton upper part 30 (cf. FIG. 4). The axial extent of the stop tab 67 is dimensioned in such a manner that, in the assembly, when the latching projection 64 bears against the lower edge 41 of the window 40, there is an axial distance between the free end edge 68 and the upper edge 43, so that a clearance or gap 72 is formed (cf. FIG. 4).

The slide guide 66 (cf. FIG. 3) has a base plate 75 which is essentially in the form of a circular disk and the outside diameter of which corresponds approximately to the inside diameter of the tube section 60, 32a, 61?. Spaced apart opposite one another, circular disk segments 76 are integrally formed on the base plate 75 and have an outside diameter which corresponds to the outside diameter of the tube section 61 or the inside diameter of the cylindrical tube section 32a. The circular disk sections 76 are of thicker design than the base plate 75 and have opposite, parallel, plane guide surfaces 77 which, together with the base plate 75, serve for the displaceable mounting of a slide 78 which will be described in more detail further below. The base plate 75 therefore forms, together with the guide surfaces 77, a cross-sectionally u-shaped guide groove for the slide 78.

The slide 78 is a first coupling link and has a three-dimensional form essentially in the shape of a disk and has rectilinear, opposite guide edges 79 which interact with the guide surfaces 77, so that guiding of the slide 78 between the circular disk sections 76 is ensured. The end edges of the slide 78 are in the form of a circular arc. The outside diameter of the slide 78 between the end edges corresponds to the inside diameter of the cylindrical tube section 32a. A u-shaped recess 80 extends from one of the guide edges 79 into the interior of the slide 78. In the assembly, the eccentric nipple 53 of the lock cylinder 4 engages in this u-shaped recess 80. In the assembly, the slide guide 66 sits with the circular disk sections 76 on the end steps 65 of the tube section 61. The slide guide 66 can be displaced together with the slide 78 or the pushbutton lower part 31 in a double arrow direction or axial direction 81 (FIG. 10), the slide guide 66 being guided along the free side edges 69 of the stop tab 67.

The construction of the locking device 5 will be described in detail below with reference to FIGS. 5 and 6.

The housing part 22 has a three-dimensional shape which, as viewed from the side, is essentially L-shaped and U-shaped in cross section, with a housing base wall 91, a first, L-shaped side wall 92 and a second, L-shaped side wall 93 and an end side wall 94. The second side wall 93 has the outer surface 27 in the region of the plug-in opening 15, which outer surface, together with the plug-in opening 15, forms a cross-sectionally circular passage. The base wall 91 has, in the region of the long limb 24, a first, long base wall section 91a and, in the region of the second, short limb 25, a second, short base wall section 91b. The base wall sections 91a and 91b merge one in the other with a base wall curved section 91c.

The first side wall 92 has a first, long side wall section 92a in the region of the first, long limb 24, a second, short side wall section 92b in the region of the second, short limb 25 and a side wall curved section 92c in between. The second side wall 93 has a first, long side wall section 93a in the region of the first, long limb 24, a second, short side wall section 93b in the region of the second, short limb 25 and a side wall curved section 93c in between, the first, long side wall section 93a and the side wall curved section 93c together in the assembly forming a surface which is aligned with the surface of the handle body 2.

In the assembly, the end side wall 94 bears flush against the free end 18 of the blind-hole recess 17. The end side wall 94 has, in the region of the side wall 92, two recesses 95 through which the electric lines 26 can be led out of the housing interior.

A motor axial drive 100, for example a lifting magnet with a magnet body 101 and a piston rod 102, which is guided in a central hole and protrudes out of the hole, is arranged in the region of the first limb 24. The piston rod 102 is connected outside the magnet body 101 via a transverse pin 103 to a drag lever or drag arm 104 which sits in front of the head on the piston rod. The drag lever 104 has, in the region of its free end 105, a slot-type recess 106 which extends perpendicularly with respect to the longitudinal extent and in which is mounted a pin 107 which extends transversely with respect thereto and via which the drag lever 105 is connected to a lever arm 111 of a two-armed reversing lever 108. The reversing lever 108 has a hole 109 with which it is mounted pivotably on a cylinder 110a having an axis 110 which extends away vertically from the base wall 91 in the region of the base wall curved section 91c. The reversing lever 109 has a second lever arm 112 lying opposite the first lever arm 111. The axial drive 100, the drag lever 104 and the first lever arm 111 of the reversing lever 108 are arranged in the region of the first limb 24 of the housing 21. The second lever arm 112 of the reversing lever 108 protrudes from the axis 110 into the second limb 25 of the housing 21. The reversing lever 108 has an actuating section 113 in the region of the free end of the second lever arm 112. The actuating section 113 tapers toward the free end and has a sliding surface 114 which points in the assembly toward the plug-in opening 15. Axial extension of the axial drive 100 in a direction 120 causes the reversing lever to pivot via the drag lever 104 about the axis 110 in a direction 121.

The second base wall section 91b has a rectangular, L-shaped angled groove 122 with a first, short groove limb 122a and a second, long groove limb 122b. The first groove limb 122a runs parallel to the actuating direction 120 of the axial drive 100. The second groove limb 122b runs parallel to the actuating longitudinal axis 14. At the free end of the first groove limb 122a, the latter ends in the transition region between the base wall section 92c and the second side wall section 92b of the side wall 92. A stop console 123 for the slide 28, which will be described further below, is integrally formed, laterally aligned with the groove limb 122a, on the inside of the second side wall section 92b. Opposite the second side wall section 92b, the side wall section 93b has, below the outer surface 27, a recess from which the slide 28 protrudes.

The slide 28 is a further coupling link and has a slide plate 130 and a stop tab or stop web 131 which, perpendicularly from the slide plate 130, extends away from the end of the slide plate 130 in the region of one end thereof. The stop tab 131 has a free edge 131a and has a width which is smaller than or equal to the clear width of the windows 40. In the region of the other end of the slide plate 130, a projection 132 is integrally formed on each side of the slide plate 130. In the assembly, the projections 132 run in the angled groove 122, i.e. they are in engagement with the angled groove limbs 122a and 122b. Opposite the angled groove 122 in the base wall 91, an angled groove 122′ with a first angled groove limb 122a′ and a second angled groove limb 122b′ is likewise formed in the cover 23. The angled grooves 122 and 122′ serve for guiding the slide 130. In an operating position, the slide plate 130 rests on the supporting console 123. The slide plate 130 furthermore has an essentially square reach-through window 133 through which the free end 113 of the reversing lever 108 reaches. The stop tab 131 of the slide 28 has a three-dimensional shape which is in the form of a cylindrical tube wall and the inside diameter of which corresponds approximately to the outside diameter of the tube section 61 and the outside diameter of which corresponds approximately to the outside diameter of the cylindrical tube section 32a. As an extension of the slide plate 130, a slide projection 134 which has a channel in the form of a circular arc at its free end extends beyond the stop tab 131, the channel approximately corresponding in respect of its diameter to the inside diameter of the tube section 61.

The housing 21, in which the axial drive 100, the drag lever 104, the reversing lever 108 and the slide 28 are mounted, therefore form the locking driving device 5 which can be inserted into the handle body 2 in the manner of a module or cassette.

The assembly of the actuating apparatus 1 will be described in more detail below with reference to FIG. 7 as a supplement to the previous description.

In the assembly, the compression spring 6 at one end is supported on a base wall of the receiving device 16 and at the other end rests against the annular end surface 35 of the cylindrical tube section 32a of the pushbutton upper part 30. The pushbutton lower part 31 is connected by means of the previously described clip connection to the pushbutton upper part 30 in a manner such that they can be displaced axially in the direction 81. The pushbutton upper part 30 is mounted in the handle body 2 by means of the sealing ring 32 in the plug-in opening 15 in interaction with the outer surface 27. The pushbutton lower part 31 reaches through a hole in the base wall of the receiving device 16 and is connected to the actuating element 8. The reversing lever 108 reaches with its free end 113 through the slide plate 130 of the slide 28, the slide 28 being guided in the grooves 122, 122′ in the housing 21. The windows 40 of the pushbutton 3 are arranged in such a manner that the window 40, in which the stop tab 67 of the pushbutton lower part 31 is arranged, lies opposite the slide 28. The slide 78, which can be actuated manually via the lock cylinder 4, is in engagement with the eccentric nipple 53 of the lock cylinder 4 and can be displaced to and fro by means of the eccentric nipple 53 in a direction perpendicular with respect to the axis 14, for example by rotation of the lock cylinder 4 by a key.

In the following, a first operating position (“central locking system or locking device 5 open”) will be described with reference to FIGS. 7 and 8. In the position according to FIG. 7, the pushbutton 3 is not actuated and, in the position according to FIG. 8, it is actuated, i.e. pushed in.

According to FIG. 7, the axial drive 100, i.e. the lifting magnet, is energized, so that the push rod 102 is drawn in. In this position, the lever arm 112 of the reversing lever 108 is positioned in such a manner that the sliding surface 114 is oriented parallel to the actuating longitudinal axis 14. The slide 28 sits with its guide projections 132 in the corner region of the angled groove 122, so that the stop tab 131 of the slide 28 comes to bear against the stop tab 67 of the pushbutton lower part 31 and the free end edge 131a rests on the step 71. Furthermore, the upper edge 43 of the window 40, which faces the slide 28, in the pushbutton upper part 30 sits on the slide plate 130. In addition, the projection 134 rests on the free end edge 68 of the stop tab 67. The pushbutton upper part 30 is therefore connected to the pushbutton lower part 31, in a manner coupled in a form-fitting manner via the slide 28, said pushbutton lower part in turn being connected in a form-fitting manner to the actuating element 8, so that pressing on the compressive part 33 according to FIG. 8 causes the pushbutton upper part 30 together with the slide 28 and the pushbutton lower part 31 and the actuating element 8 to be displaceable by the length 1 (cf. FIG. 8). In this position, the slide 28 with its projections 132 is situated at the free end of the second groove limb 122b or 122b′. The compression spring 6 is compressed. Release of the compressive part 33 causes the compression spring 6 to expand and to bring the pushbutton 3 back into the starting position according to FIG. 7. Extension of the actuating element 8 by the length l causes a lock mechanism to be actuated (not illustrated).

In the second operating position according to FIGS. 9 and 10 (“central locking system” closed), the axial drive 100 or the lifting magnet 101 is connected currentlessly, so that the push rod 102 is extended. The actuating lever arm 112 of the reversing lever 108 is pivoted toward the console 123 and bears against the console 123. During the pivoting, it has carried along the slide 28 which, in the retracted position, rests in the free end of the groove limb 122a, with the slide plate 130 resting on the console 123. In this position, the stop tab 131 of the slide 28 is arranged spaced apart from the stop tab 67 of the pushbutton lower part 31, so that the upper edge 43 of the window 40 facing the slide 28 is exposed. Otherwise, all of the remaining components of the actuating apparatus 1 are in the position according to FIG. 7. When the pushbutton 3 is actuated by being pressed in the arrow direction according to FIG. 10, in this operating position there is no form-fitting or frictional connection between the pushbutton upper part 30 and the pushbutton lower part 31, so that the pushbutton upper part 30 can be displaced in the axial direction 14 relative to the pushbutton lower part 31. The pushbutton upper part 30 and the pushbutton lower part 31 are mechanically decoupled. The pushing according to FIG. 10 therefore merely causes the pushbutton upper part 30 to be displaced axially, so that the compression spring 6 is compressed. The pushbutton lower part “remains” in its starting position according to FIG. 9, so that an actuation of a lock mechanism (not shown) by the actuating element 8 does not occur and an extension of the actuating element 8 by the length l is therefore prevented. In this “empty stroke”, the latching projections 64 are lifted off from the lower edges 61. The latching projections 64 and the supporting projection 70 are guided between the side edges 42 of the windows 40 in the cylindrical tube section 32a and are displaced relative to the pushbutton upper part 30. Release of the pushbutton 3 enables the pushbutton upper part to be displaced by the compression spring 6 back into the starting position according to FIG. 9. In this position, an opening of a motor vehicle door or of the motor vehicle flap (not illustrated) is therefore not possible, since the actuating element 8 is mechanically decoupled from the pushbutton upper part 3.

In the operating position of the locking device 5 according to FIGS. 9 and 10, i.e. the operating position “central locking system closed”, the actuating device 3, 30, 31 can be mechanically coupled manually in a conventional manner by inserting the key into the lock cylinder 4 and rotating the same. After the key has been inserted into the lock cylinder 4, the rotating body 51 is rotatable. Rotation of the rotating body 51 about the axis 14 causes the eccentric nipple 53 to be moved from the position according to FIG. 9 (on the right of the longitudinal axis 14) into an open position (on the left of the longitudinal axis 14 (not shown)). By this means, the slide 78 is displaced from its position shown in FIG. 9 to the left, so that it comes to lie over the free edge 68 of the stop tab 67 of the pushbutton lower part 31. In this case, it can also displace the slide 28 if the latter is in the position according to FIG. 7 because the locking device 5 is preferably set up in such a manner that it can be displaced. In this position, pushing of the pushbutton 3 causes the actuating element 8 to be actuated, since the pushbutton upper part 30 is mechanically coupled to the actuating element 8 via the lock cylinder 4, the slide 78 and the stop tab 67 of the pushbutton lower part 31. An actuation of the lock can therefore be achieved purely manually even, for example, if the current should fail.

According to the invention, instead of the axial drive 100, a rotation drive, in particular an electric motor 200, is now provided with a driving worm 201 which is preferably guided in a central bore and projects out of the latter in the direction of the pushbutton 3 and has a driving worm thread 203 (FIGS. 11-13). In this case, the driving worm 201 is expediently arranged with its longitudinal axis or axis of rotation 202 perpendicular to the actuating longitudinal axis 14 and parallel to a longitudinal direction 219 of the handle body 2.

In addition, according to the invention, the reversing lever 108 does not have a first lever arm 111, but rather, opposite the lever arm 112, has a toothed rim segment 204 which runs in a curve and the oblique toothing 205 of which is designed such that it corresponds to the driving worm thread 203. The toothed rim segment 204 is dimensioned and arranged in such a manner that, in the assembled state, the oblique toothing 205 is in engagement with the driving worm thread 203. The toothed rim segment 204 expediently runs in a curved manner with respect thereto such that a toothed rim center axis 209 is parallel to the axis 110 or is preferably coaxial with respect thereto.

In addition, according to the embodiment illustrated in FIGS. 11-13, the pushbutton lower part 31 does not have any latching projections 64, but rather the stop tab 67, which is in particular in the form of a section of a cylindrical tube, is offset radially outward with respect to the tube section 61 in such a manner that the stop tab 67 merges into the tube section 61 via an annular web 207. The annular web 207 is preferably of encircling design and has an encircling annular web outer edge 209. In this case, the outside diameter of the stop tab 67 or of the annular web outer edge 209 corresponds to the inside diameter of the cylindrical tube section 32a of the pushbutton upper part 30, and therefore the pushbutton lower part 31 is guided in a sliding manner in the cylindrical tube section 32a of the pushbutton upper part 30 in the direction 81 of the actuating longitudinal axis 14.

In order to upwardly secure the pushbutton upper part 30 in the axial direction 81 against slipping out, two securing pins 211 are provided. The securing pins 211 are mounted in each case two radially opposite bores 218 which are provided in the lower region of the cylindrical tube section 32a, in the vicinity of the annular end surface (35). In this case, the bores 218 are arranged in such a manner that the two securing pins 211 are parallel to each other and are spaced apart from each other by the magnitude of the outside diameter of the tube section 61 of the pushbutton lower part 31, and therefore the securing pins 211 bear against a tube section outer wall 61a and can slide along the latter. When not pressed (FIG. 12), the pushbutton upper part 30 is pressed upward in the direction of the actuating longitudinal axis 14 by the compression spring 6, and therefore the securing pins 211 bear at the bottom against the annular web 207, which serves as a stop, and the pushbutton upper part 30 is secured against slipping out upward. When the pushbutton upper part 30 is actuated, the securing pins 211 slide downward along the tube section outer wall 61a.

Furthermore, the slide guide 66 is integrated into the pushbutton upper part 30, i.e. formed integrally with the pushbutton upper part 30. In this case, the slide guide 66 is essentially inwardly joined to the tube section 32a.

In addition, the pushbutton upper part 30 merely has only one window 40 for receiving the slide 28.

The actuation of the actuating apparatus according to the invention takes place as already described in detail above by means of mechanical coupling or decoupling of pushbutton upper part 30 and pushbutton lower part 31 by displacement of the slide 28 by means of the reversing lever 108, with the slide 28, in the coupled position illustrated in FIGS. 12 and 13, resting on the free end edge 68 of the stop tab 67 and being supported thereon. By pressing of the compressive part 33 of the pushbutton 3, the pushbutton lower part 31 and, together therewith, the actuating element 8 are also actuated via the slide 28 and carried along downward in the axial direction (FIG. 13). In this position, the slide 28 is located with its projections 132 at the free end of the second groove limb 122b or 122b′. The compression spring 6 is compressed. Releasing the compressive part 33 causes the compression spring 6 to be expanded and causes the pushbutton 3 to be brought again into the starting position according to FIG. 12. By extension of the actuating element 8 by the length l, a lock mechanism is actuated (not illustrated), as already explained.

In order to bring the pushbutton upper part 30 and the pushbutton lower part 31 into the mechanically decoupled position (not illustrated) by operation by means of central locking, the electric motor 200 is switched on and the driving worm 201 set by the latter into rotation. The rotational movement of the driving worm 201 is then transmitted via the driving worm thread 203 to the oblique toothing 205 of the toothed rim segment 204, and the reversing lever 108 is pivoted about the axis 110 such that the lever arm 112 is moved away from the pushbutton 3 and, as already explained above, carries along the slide 28, and therefore the pushbutton upper part 30 and the pushbutton lower part 31 are mechanically decoupled. In this position, the pushbutton upper part 30 can be displaced freely downward without carrying along the pushbutton lower part 31, with the cylindrical tube section 32a sliding along the annular web outer edge 209 and the stop tab 67 such that the pushbutton upper part 30 and the pushbutton lower part 31 are displaced one inside the other and the actuating element 8 is not actuated.

The pivoting back of the reversing lever 108 into the coupled position illustrated in FIGS. 12 and 13 takes place by renewed driving of the driving worm 201 in the opposite direction of rotation by means of the electric motor 200.

The coupling or decoupling with the aid of a key likewise takes place, as already described in detail above, by actuation of the slide 78 via the eccentric nipple 51.

On account of the direct actuation of the reversing lever 108 by the driving worm 201, the actuating apparatus according to the invention requires very little construction space and, because of the small number of individual components, it is very easy and staightforward to fit.

Of course, it is also possible, within the scope of the invention, to design pushbutton upper part 30 and pushbutton lower part 31 according to the previously described embodiments with latching projections 64 and two windows 40, etc, or with a separate slide guide 66.

According to a further embodiment of the invention, the actuating device for actuating the lock by central locking likewise has a locking device 5 with a rotation drive, in particular an electric motor 220, which has a driving worm 221 which is preferably guided in a central bore and projects out of the latter and has a driving worm thread 222 (FIGS. 14-23). The driving worm 221 is expediently likewise arranged with its longitudinal axis or axis of rotation 223 perpendicular to the actuating longitudinal axis 14, but at an angle with respect to the longitudinal direction 219 of the handle body 2.

Furthermore, the locking device according to FIGS. 14-23 has a rotatably mounted gearwheel 224 with an oblique toothing 225 corresponding to the driving worm thread 222, the axis of rotation or center axis 226 of which gearwheel is parallel to the actuating longitudinal axis 14 and is arranged in alignment therewith in the longitudinal direction 219 of the handle body 2. A cam 227 with its cam cylinder 228 and its cam elevation 229 adjoins the gearwheel 224 downward in the direction of the axis of rotation 226 of the gearwheel. The cam 227 is fixedly connected to the gearwheel 224 and is preferably formed integrally therewith. In this case, the cam 227 is arranged with its cam cylinder axis 230 coaxially with respect to the axis of rotation 226 of the gearwheel. A preferably cylindrical carrying or guiding pin 231 which extends upward parallel to the axis of rotation 226 of the gearwheel in the direction of the gearwheel 224 is provided on the cam elevation 229 which is eccentric with respect to the cam cylinder axis 230.

According to the invention, the actuating apparatus in addition likewise has a moveable coupling link, in particular a coupling lever 232. The coupling lever 232 is preferably of cuboidal design and designed such that it is essentially stretched out along a longitudinal direction 233 of the lever, with an, in particular likewise cuboidal, actuating or guiding piece 234 being arranged or integrally formed on one end. In addition, a continuous mounting bore 235 is provided approximately centrally with respect to the longitudinal extent of the coupling lever 232, the mounting bore axis 236 of which bore runs perpendicularly to the longitudinal direction 233 of the lever and coaxially with respect to the actuating longitudinal axis 14. The mounting bore 235 serves for the rotatable mounting of the coupling lever 232 on the pushbutton upper part 30 about the vertical actuating longitudinal axis 14, which is explained in more detail further below.

The guide piece 234 is offset upward with respect to the coupling lever 232 in the direction of the mounting bore axis 236 and has a journal guide slot 237 which extends in the direction of the longitudinal direction 233 of the lever and is open toward a guide piece end 234a. The width of the journal guide slot 237 preferably corresponds to the diameter of the guiding journal 231 which is arranged such that it is guided moveably in the journal guide slot 237 parallel to the direction of the longitudinal direction 233 of the lever, which is explained in more detail further on.

According to the embodiment illustrated in FIGS. 14-23, the pushbutton upper part 30 does not have any window-type cutouts 40, but rather a lever guide slot 238 which extends in the cylindrical tube section 32a somewhat below the compressive part 33 in the circumferential direction and has two slot side edges 239a,b extending parallel to the actuating longitudinal axis 14 and radially with respect thereto, a slot lower edge which is preferably flat and arranged perpendicularly with respect to the actuating longitudinal axis 14, and a slot upper edge 241 which is preferably likewise flat and is parallel to the slot lower edge 240. In this case, the slot lower edge 240 and the slot upper edge 241 are expediently spaced apart from each other by the magnitude of the thickness or height of the coupling lever 232, i.e. the distance between lever upper side 257 and lever lower side 258. The coupling lever 232 is arranged in the lever guide slot 238 with its mounting bore 235 coaxial with respect to the actuating longitudinal axis 14 and is secured axially, i.e. is axially nondisplaceable, but guided rotatably about the actuating longitudinal axis 14 by a limited magnitude.

In addition, two axial securing slots 242 which lie radially opposite each other and extend in the direction of the actuating longitudinal axis 14 and in which an axial securing pin 243 is guided are provided in the pushbutton upper part 30. The axial securing pin 243 is also mounted in a form-fitting manner in a bore 244 which is provided in the pushbutton lower part 31 and is oriented perpendicularly with respect to the actuating longitudinal axis 14, such that the pushbutton upper part 30 is connected in an axially displaceable manner to the pushbutton lower part 31 by a limited magnitude, in particular essentially corresponding to the length of the axial securing slots 242, and the pushbutton upper part 30 is secured against slipping out upward.

According to the embodiment illustrated in FIGS. 14-23, the pushbutton lower part 31 has just one short tube section 61 which is upwardly adjoined by the stop tab 67, which is in the form of a segment of a cylinder wall, as an extension. In this case, the stop tab 67 is not arranged symmetrically with respect to the longitudinal axis 219 in a plan view in the direction of the actuating longitudinal axis 14, as in the first exemplary embodiment, but rather the pushbutton lower part 31 is arranged rotated about the actuating longitudinal axis 14 in such a manner that the stop tab 67 is arranged offset with respect to the longitudinal direction 219. In particular, in a bottom view in the direction of the actuating longitudinal axis 14 of the actuating apparatus, the stop tab 67 is pivoted counterclockwise in comparison to the symmetrical arrangement.

The short tube section 61 is downwardly adjoined in the axial direction by a cylinder section 245 with the same outside diameter as the tube section 61 and said cylinder section is adjoined by the punch section 60. The bore 244 is provided perpendicularly with respect to the actuating longitudinal axis 14 in the cylinder section 245.

According to a preferred embodiment of the invention (FIG. 23), the pushbutton lower part 31 has two stop tabs 67 arranged lying radially opposite each other.

Furthermore, the pushbutton lower part 31 likewise does not have any latching projections 64.

Instead of the eccentric nipple 53, the rotating body 51 of the block cylinder 4 has a lever mounting cylinder 246 which is arranged centrally with respect to the actuating longitudinal axis 14 and protrudes for a distance downward in the axial direction from a rotating body base 247, in particular at least by the magnitude of the thickness of the coupling lever 232. In this case, the diameter of the lever mounting cylinder 246 preferably corresponds to the diameter of the mounting bore 235, and therefore the coupling lever 232, which is mounted with its mounting bore 235 on the lever mounting cylinder 246, is arranged rotatably about the actuating longitudinal axis 14. In this case, the coupling lever 232 expediently bears with the lever upper side 257 against the rotating body base 247.

Furthermore, the rotating body 51 has two rotating or actuating segments 248, 249 which lie radially opposite each other and likewise downwardly adjoin the rotating body base 247 in the axial direction. The rotating segments 248, 249 each have a segment outer edge 250 which extends, with respect to the actuating longitudinal axis 14, in the circumferential direction and the diameter of which expediently corresponds to the outside diameter of the rotating body 51, and two flat segment side edges 252a, 252b, 253a, 253b. In this case, the segment side edges 252a, 252b, 253a, 253b are dimensioned in such a manner that the segment side edges 252a, 253b and 252b, 253a which do not lie opposite each other are parallel to each other and are spaced apart from each other by the magnitude of the width of the coupling lever 232, i.e. the distance of lever side edges 254, 255 from each other, and therefore the two rotating segments 248, 249, in a plan view (FIGS. 18, 22) along the actuating longitudinal axis 14, are preferably of essentially triangular design. The two segment side edges 252a, 252b and 253a/253b of the respective stop segment 248, 249 expediently merge into each other in a rounded corner edge 256.

The actuating of the actuating apparatus according to the invention as per the embodiment illustrated in FIGS. 14-23 likewise takes place by coupling or decoupling pushbutton upper part 30 and pushbutton lower part 31. In the mechanically coupled position (FIGS. 16-18), the coupling lever 232 is pivoted about the actuating longitudinal axis 14 in such a manner that the coupling lever 232 is arranged in alignment with the stop tab or the stop tabs 67 in the direction of the actuating longitudinal axis 14 and rests with the lever lower side 258 on the free end edge or free end edges 68 of the stop tab or the stop tabs 67, with the lever longitudinal direction 233 expediently enclosing an acute angle α with the longitudinal direction 219 of the handle body 2. In this case, the slot side edge 239b of the lever guide slot 238, on which side edge the lever side edge 254 of the coupling lever 232 bears in this position, expediently serves as a stop.

The pivoting of the coupling lever 232 takes place by switching on the electric motor 220 by means of which the driving worm 221 is set into rotation. The rotational movement of the driving worm 221 is then transmitted via the worm thread 222 to the oblique toothing 225 of the gearwheel 224 which, in this case, rotates in the clockwise direction, as seen in a bottom view in the direction of the actuating longitudinal axis 14. Via the cam 227, which is connected fixedly to the gearwheel 224, and via the eccentrically arranged guiding journal 231 of the cam 227, the coupling lever is then set into rotation about the actuating longitudinal axis 14 counterclockwise, expediently until the lever side edge 255 strikes against the slot side edge 239b.

In this first operating position, the pushbutton upper part 30 is therefore mechanically coupled via the coupling lever 232 in a form-fitting manner to the pushbutton lower part 31 which, in turn, is connected in a form-fitting manner to the actuating element 8.

In the case of two stop tabs 67 being provided (FIG. 23), the two stop tabs 67 lie opposite each other in the direction of the lever longitudinal direction 233.

So that the pushbutton upper part 30 can also be actuated, the cam 227 is also arranged such that it is rotated somewhat further in the clockwise direction in relation to the coupling lever 232, and therefore the guiding journal 231 is no longer guided in the rearwardly open journal guide slot 237, and the coupling lever 232 is decoupled from the cam 227 or is moveable axially freely with respect thereto (not illustrated). How far the cam 227 is rotated by means of the electric motor 220, i.e. how long the electric motor 220 is actuated, is controlled, for example, by means of a Hall sensor 260 or similar rotation meter which is connected to a control module (not illustrated) of the actuating apparatus and measures the position of the coupling lever 232.

By pressing on the compressive part 33, the pushbutton upper part 30 can now be displaced together with the coupling lever 232 and the pushbutton lower part 31 and also the actuating element 8 by the length l (cf. FIG. 19). The compression spring 6 is compressed in the process. Release of the compressive part 33 causes the compression spring 6 to expand and the pushbutton 3 to be brought again into the starting position according to FIG. 17.

In order to bring the pushbutton upper part 30 and the pushbutton lower part 31 into the mechanically decoupled position by operation by central locking (FIGS. 19-23), the electric motor 220 is switched on and the driving worm 221 is set by it into rotation in the direction opposite to the direction for bringing the coupling lever 232 into the coupled position. The rotational movement of the driving worm 221 is then in turn transmitted via the worm thread 222 to the oblique toothing 225 of the gearwheel 224 and therefore to the cam 227, which is connected fixedly to the gearwheel 224, and the coupling lever 232 is pivoted via the eccentrically arranged guiding journal 231 of the cam 227 about the actuating longitudinal axis 14, this time in the clockwise direction. The coupling lever 232 is pivoted until it is no longer arranged in alignment with the stop tab or the stop tabs 67 in the direction of the actuating longitudinal axis 14 and no longer rests with the lever lower side 258 on the free end edge or free end edges 68 of the stop tab or the stop tabs 67. This time, the stop is expediently the slot side edge 239a against which the coupling lever 232 strikes and bears by means of its lever side edge 255.

The lever longitudinal direction 233 expediently then encloses an acute angle β with the longitudinal direction 219 of the handle body 2, which angle corresponds in terms of magnitude to the angle α and, with respect to the longitudinal direction 219 of the handle body 2, has the reverse sign, i.e. the coupling lever 232 is arranged in a mirror-inverted manner with respect to the longitudinal direction 219 in comparison to the coupled position (FIGS. 16-19). The cam 227 is again arranged (not illustrated) rotated somewhat further in relation to the coupling lever 232, this time counterclockwise, as seen in a bottom view, and therefore the guiding journal 231 is no longer guided in the rearwardly open journal guide slot 237, and the coupling lever 232 is decoupled from the cam 227 or is axially moveable freely with respect thereto. The electric motor 220 is expediently again controlled via the Hall sensor 260.

In the mechanically decoupled position, by pressing on the compressive part 33, only the pushbutton upper part 30 together with the coupling lever 232 is displaced downward in the direction of the actuating longitudinal axis 14, since the coupling lever 232 is guided past the stop tab or the stop tabs 67. The pushbutton lower part 31 and the actuating element 8 are not actuated (FIG. 23).

When the actuating apparatus is actuated by central locking, the lock cylinder 4 is initially in a central position (FIGS. 18, 22) in which it is held in a manner known per se by a torsion spring or center-zero spring 259. In this central position, the two rotating segments 248, 249 are expediently arranged symmetrically with respect to the longitudinal direction 219 in such a manner that, in the coupled position of the coupling lever 232, the segment side edges 252b, 253a are parallel to the lever side edges 254, 255 and, in the decoupled position of the coupling lever 232, the segment side edges 252a, 253b are parallel to the lever side edges 254, 255 such that the coupling lever 232 can be pivoted by central locking in an unobstructed manner.

The manual actuation of the actuating apparatus by means of a key likewise takes place by rotation of the rotating body 51 of the lock cylinder 4, which rotating body can be rotated about the actuating longitudinal axis 14 after the key is plugged into the lock cylinder 4. By rotation of the rotating body 51 in the clockwise direction, the coupling lever 232 is carried along in a form-fitting manner by the rotating segments 248, 249, for example out of the coupled position (FIG. 18) in which the lever side edge 255 bears against the segment side edge 253a and the lever side edge 254 bears against the segment side edge 252b, and is rotated until the coupling lever 232 strikes with its lever side edge 255 against the slot side edge 239a, and therefore the coupling lever 232 is in the mechanically decoupled position.

After release of the key, the center-zero spring 259 rotates the lock cylinder 4 back again into the central position.

The rotation of the coupling lever 232 from the decoupled position (FIG. 22) into the coupled position (FIG. 18) takes place analogously by rotation of the lock cylinder counterclockwise, with the lever side edge 255 bearing against the segment side edge 253b and the lever side edge 254 bearing against the segment side edge 252a, and therefore the coupling lever 232 is carried along in a form-fitting manner by the rotating segments 248, 249 and is rotated until the coupling lever 232 strikes with its lever side edge 255 against the slot side edge 239 and bears against it.

After the key is released, the center-zero spring 259 again rotates the lock cylinder 4 back into the central position.

In this embodiment of the invention, it is advantageous that no additional component is necessary for the manual actuation of the actuating apparatus, which considerably simplifies the entire structure. The coupling lever can be operated both manually and also by central locking. In addition, on account of the small number of components, this embodiment of the invention also has a very small construction space and is therefore particularly easy and straightforward to fit. Of course, it is also possible, within the scope of the invention, likewise to design the locking device in a modular manner.

In the case of the actuating apparatus according to the invention, it is particularly advantageous therefore, in summary, that the latter is of particularly compact construction and permits the manual closing and opening and also a remotely actuable opening and closing. It is particularly advantageous if the electrically controllable locking device 5 is designed in the manner of a module or cassette and is inserted into the handle body, and a variation of the actuating apparatus with and without a remote-controllable unlocking functionality can therefore be realized in a simple manner. By means of omission of the locking device 5 and by means of a simple closing of the slot-type recess in the handle body 2 by a cover or a panel (not shown), the actuating apparatus according to the invention can optionally be designed with and without a remote-triggering functionality. A costly installation, for example in a door body of a motor vehicle, as conventionally takes place, is unnecessary.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. An actuating apparatus for a lock mechanism of a door or flap of a motor vehicle, comprising
a) a handle body,
b) an actuating device arranged to drive an actuating element for the lock mechanism, said actuating device being is mounted in an end region of said handle body,
c) a coupling link between the actuating device and the actuating element which, when moved, brings the actuating device out of operation,
d) a locking device being connected to and arranged to be driven by said coupling link, and having a rotation drive responsive to remote controls, the locking device being located in subregions of the handle body other than said end region.

18. The actuating apparatus as claimed in claim 1, wherein the rotation drive comprises an electric motor.

19. The actuating apparatus as claimed in claim 18, wherein the rotation drive is connected to the coupling link, via a pivoting reversing lever.

20. The actuating apparatus as claimed in claim 19, wherein a driving worm having a driving worm thread is connected between the reversing lever and the rotation drive.

21. The actuating apparatus as claimed in claim 20, wherein the driving worm has a toothed rim segment and oblique toothing that corresponds to the driving worm thread.

22. The actuating apparatus as claimed in claim 21, wherein the reversing lever is mounted so as to pivot about a pivoting axis perpendicular to a vertical actuating longitudinal axis.

23. The actuating apparatus as claimed in claim 22, wherein the toothed rim segment is integrally formed on the reversing lever.

24. The actuating apparatus as claimed in claim 22, wherein a toothed rim center axis is coaxial with respect to the pivoting axis.

25. The actuating apparatus as claimed in claim 19, comprising a further coupling link, said further coupling link being arranged so as to be actuated manually.

26. The actuating apparatus as claimed in claim 25, wherein the further coupling link comprises a slide.

27. The actuating apparatus as claimed in claim 19, wherein the coupling link comprises a slide.

28. The actuating apparatus as claimed in claim 27, wherein a driving worm, which has a driving worm thread, is arranged so as to be connected so as to be driven by the electric motor.

29. The actuating apparatus as claimed in claim 27, wherein the actuating apparatus has a rotatably mounted gearwheel with an oblique toothing corresponding to the driving worm thread, said gearwheel being arranged so as to be connected so as to be driven by the driving worm.

30. The actuating apparatus as claimed in claim 28, wherein a cam is fixedly connected to the gearwheel.

31. The actuating apparatus as claimed in claim 30, wherein the coupling link is a coupling lever which is mounted so as to rotate about the vertical actuating longitudinal axis.

32. The actuating apparatus as claimed in claim 31, wherein the coupling lever is connected so as to be driven by the cam.

33. The actuating apparatus as claimed in claim 31, wherein a carrying or gliding journal is provided on an elevation of the cam.

34. The actuating apparatus as claimed in claim 33, wherein the coupling lever is connected so as to be driven by the electric motor via the carrying journal of the cam and the gearwheel and the driving worm.

35. The actuating apparatus as claimed in claim 17, wherein the motor vehicle comprises a tractor.
